(19) United States
(12) Patent Application Publication
(10) Pub. No.: US 2023/0285782 A1
(43) Pub. Date: Sep. 14, 2023

(54) HIGH-FILTRATION REUSABLE FACE MASK WITH TEXTURED CONTACT PORTION AND VARIOUS COUPLING MECHANISMS

(71) Applicant: Teal Bio, Inc., Sommerville, MA (US)

(72) Inventors: Jason Troutner, Boston, MA (US); Nimeesh RAHATE, Brighton, MA (US)

(73) Assignee: Teal Bio, Inc., Sommerville, MA (US)

(21) Appl. No.: 18/120,074

(22) Filed: Mar. 10, 2023

Related U.S. Application Data
(60) Provisional application No. 63/319,072, filed on Mar. 11, 2022.

(51) Int. Cl. A62B 18/02; A62B 23/02

(52) U.S. Cl. CPC A62B 18/025; A62B 23/02; A62B 18/084

(57) ABSTRACT

Provided are reusable face masks comprising a single piece mask body configured to cover a nose and a mouth of a human face and comprising at least one filter attachment port, wherein the at least one filter attachment port comprises a coupling mechanism, defines an opening in the mask body, and extends from the exterior surface of the mask body; wherein the coupling mechanism comprises a proximal portion proximate to the exterior surface of the face mask body and a plurality of protrusions extending from the proximal portion and away from the exterior surface of the mask body, wherein the coupling mechanism of the at least one filter attachment port is configured to connect to a replaceable filter. The reusable face mask may comprise a user-facing textured rim configured to come in contact with a user’s face when properly worn by the user.

### CROSS-REFERENCE TO RELATED APPLICATIONS

This application claims the benefit of U.S. Provisional Application No. 63/319,072 filed Mar. 11, 2022, the entire contents of each of which are incorporated herein by reference.

### FIELD

The present disclosure relates to reusable face masks, and more particularly, to reusable face masks having replaceable filters.

### BACKGROUND

Conventional high-filtration face masks (e.g., N95 masks) include one-time use masks and reusable respirators with replaceable filters. High-filtration face masks filter out a majority of particles in the air, including infectious particles (e.g., viruses) when properly fitted to a user. Such face masks are commonly used in industry (e.g., mining, construction, painting) and healthcare. High-filtration face masks are also commonly used by people when in public places for protection from airborne diseases.

### SUMMARY OF THE DISCLOSURE

Conventional high-filtration face masks are generally uncomfortable to wear for extended periods of time, particularly due to restricted breathability and reduced air flow as compared to that which is experienced without a face mask. Specifically, reusable face masks made of a polymeric material can have a tacky feel, which can be uncomfortable for a user. Further, such reusable high-filtration masks can include one or more removeable and replaceable filters. However, the coupling mechanism used in conventional high-filtration masks may provide less of a seal and/or be relatively difficult to uncouple.

Accordingly, provided herein are high-filtration reusable face masks having a polymeric body piece with a contact portion (i.e., the portion of the body that comes in direct contact with a user’s face) that is less tacky than that of conventional reusable face masks made of a polymeric material. Also provided herein are various snap-fittings that may be incorporated into high-filtration face masks described herein, ensuring an adequate seal yet also able to be easily uncoupled, such that a used filter can be easily removed and replaced with a new filter.

In some embodiments, a high-filtration reusable face mask can include a mask body comprising one or more filter attachment ports to which the replaceable filters are configured to removeably attach. The one or more filter attachment ports extend from an exterior surface of the mask body and each include a filter support structure. The one or more filter attachment ports are configured to receive one or more replaceable filters (e.g., one replaceable filter per filter attachment port), such that the filter support structure of the filter attachment port causes the two sheets of filter media of the replaceable filter to separate and the replaceable filter to assume an expanded configuration. By separating the two sheets of filter media of the replaceable filter, the replaceable filter can allow more air to enter and exit the filter with each inhale and exhale, respectively.

The one or more attachment ports may include any of various couplings or fittings, as described herein. For example, the attachment port may include an elastic plug snap (described in detail with respect to FIGS. 3A-3C), a cantilever snap insert with fill (described in detail with respect to FIGS. 4A and 4B), a cantilever snap insert without fill (described in detail with respect to FIGS. 5A and 5B), or a twist and lock coupling mechanism (described in detail with respect to FIGS. 7A and 7B).

In some embodiments, provided is a reusable face mask, the reusable face mask comprising: a single piece mask body configured to cover a nose and a mouth of a human face and comprising at least one filter attachment port, wherein the at least one filter attachment port comprises a coupling mechanism, defines an opening in the mask body, and extends from the exterior surface of the mask body; wherein the coupling mechanism comprises a proximal portion proximate to the exterior surface of the face mask body, and a plurality of protrusions extending from the proximal portion and away from the exterior surface of the mask body, and a flange between the exterior surface and the proximal portion, wherein the coupling mechanism of the at least one filter attachment port is configured to connect to a replaceable filter, and the flange is configured to provide a seal between the mask body and the replaceable filter.

In some embodiments of the reusable face mask, the proximal portion and the plurality of protrusions surround the opening in the face mask body.

In some embodiments of the reusable face mask, the plurality of protrusions extending from the proximal portion of the coupling mechanism are configured to support the replaceable filter by separating portions of filter media of the replaceable filter when the replaceable filter is attached to the at least one filter attachment port.

In some embodiments of the reusable face mask, the coupling mechanism comprises a connection portion located between the exterior surface of the face mask body and the proximal portion, wherein the diameter of the connection portion is less than the diameter of the proximal portion.

In some embodiments of the reusable face mask, the connection portion is cylindrical.

In some embodiments of the reusable face mask, the replaceable filter is configured to snap over the proximal portion of the coupling mechanism such that an opening of the replaceable filter surrounds the connection portion.

In some embodiments of the reusable face mask, the coupling mechanism comprises a compression ring, the compression ring comprising the flange.

In some embodiments of the reusable face mask, the compression ring is integral with the single piece face mask body.

In some embodiments of the reusable face mask, the compression ring is a separate component from the single piece face mask body.

In some embodiments of the reusable face mask, the compression ring forms an axial seal between the face mask and the replaceable filter.

In some embodiments of the reusable face mask, the coupling mechanism is configured to receive the replaceable filter by a snap fit mechanism.

In some embodiments of the reusable face mask, the plurality of protrusions extending from the proximal portion are triangular in shape, and the coupling mechanism is configured to receive the replaceable filter by a twist and lock mechanism.

In some embodiments of the reusable face mask, the mask body comprises a transparent polymer.

In some embodiments of the reusable face mask, the mask body comprises a polymer having a transmittance of 80% or greater.

In some embodiments of the reusable face mask, the mask body comprises one of silicone or thermoplastic polyurethane.

In some embodiments of the reusable face mask, the reusable face mask comprises a user-facing rim comprising a textured surface, wherein the rim is configured to come in contact with a user’s face when the reusable face mask is properly worn by the user.

In some embodiments, provided is a reusable face mask, the reusable face mask comprises: a mask body configured to cover a nose and a mouth of a human face and comprising at least one filter attachment port, wherein the at least one filter attachment port comprises a coupling mechanism, defines an opening in the mask body, and extends from the exterior surface of the mask body; wherein the coupling mechanism comprises a rigid plastic portion and a flange, the rigid plastic portion comprising at least a portion of a proximal portion of the coupling mechanism proximate to the exterior surface of the face mask body and a plurality of protrusions extending from the proximal portion and away from the exterior surface of the mask body, and the flange positioned between the exterior surface and the proximal portion, wherein the coupling mechanism of the at least one filter attachment port is configured to connect to a replaceable filter, and the flange is configured to provide a seal between the mask body and the replaceable filter.

In some embodiments of the reusable face mask, the proximal portion and the plurality of protrusions surround the opening in the face mask body.

In some embodiments of the reusable face mask, the plurality of protrusions of the coupling mechanism of the at least one filter attachment port are configured to support the replaceable filter by separating portions of filter media of the replaceable filter when the replaceable filter is attached to the at least one filter attachment port

In some embodiments of the reusable face mask, the coupling mechanism comprises a connection portion located between the exterior surface of the face mask body and the proximal portion, wherein the diameter of the connection portion is less than the diameter of the proximal portion.

In some embodiments of the reusable face mask, the connection portion is cylindrical.

In some embodiments of the reusable face mask, the replaceable filter is configured to snap over the proximal portion of the coupling mechanism until an opening of the replaceable filter surrounds the connection portion, such that the flange is between the replaceable filter and the exterior surface of the mask body.

In some embodiments of the reusable face mask, the coupling mechanism comprises a compression ring, the compression ring comprising the flange.

In some embodiments of the reusable face mask, the compression ring is integral with the single piece face mask body.

In some embodiments of the reusable face mask, the compression ring is a separate component from the single piece face mask body.

In some embodiments of the reusable face mask, the compression ring forms an axial seal between the face mask and the replaceable seal.

In some embodiments of the reusable face mask, the proximal portion comprises a plurality of protrusions and a plurality of opening between the plurality of protrusions.

In some embodiments of the reusable face mask, the proximal portion comprises both rigid plastic and silicone components.

In some embodiments of the reusable face mask, the mask body comprises a transparent polymer.

In some embodiments of the reusable face mask, the mask body comprises a polymer having a transmittance of 80% or greater.

In some embodiments of the reusable face mask, the mask body comprises one of silicone or thermoplastic polyurethane.

In some embodiments of the reusable face mask, the rigid plastic portion comprises polycarbonate.

In some embodiments of the reusable face mask, the reusable face mask comprising a user-facing rim comprising a textured surface, wherein the rim is configured to come in contact with a user’s face when the reusable face mask is properly worn by the user.

In some embodiments, a reusable face mask is provided, the reusable face mask comprising: a mask body configured to cover a nose and a mouth of a human face and comprising at least one filter attachment port and a user-facing rim comprising a textured surface, wherein the at least one filter attachment port is configured to connect to a replaceable filter, and the rim is configured to come in contact with a user’s face when the reusable face mask is properly worn by the user.

In some embodiments of the reusable face mask, the mask body is a single piece face mask.

In some embodiments of the reusable face mask, the only portion of the mask body configured to come in contact with a user’s face when the reusable face mask is properly worn is the textured user-facing rim.

In some embodiments of the reusable face mask, the textured rim is formed with one of a D1, D2, or D3 surface/finish using an injection mold.

In some embodiments of the reusable face mask, the at least one filter attachment port comprises a coupling mechanism, defines an opening in the mask body, and extends from the exterior surface of the mask body.

In some embodiments of the reusable face mask, the coupling mechanism comprises a proximal portion proximate to the exterior surface of the face mask body, and a plurality of protrusions extending from the proximal portion and away from the exterior surface of the mask body, and a flange between the exterior surface and the proximal portion, wherein the flange is configured to provide a seal between the mask body and the replaceable filter.

In some embodiments of the reusable face mask, the coupling mechanism comprises a compression ring, the compression ring comprising the flange.

In some embodiments of the reusable face mask, the compression ring is integral with the single piece face mask body.

In some embodiments of the reusable face mask, the compression ring is a separate component from the single piece face mask body.

In some embodiments of the reusable face mask, the compression ring forms an axial seal between the face mask and the replaceable filter.

In some embodiments of the reusable face mask, the mask body comprises a transparent polymer.

In some embodiments of the reusable face mask, the mask body comprises a polymer having a transmittance of 80% or greater.

In some embodiments of the reusable face mask, the mask body comprises one of silicone or thermoplastic polyurethane.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a perspective view of a reusable face mask with two attached filters, a nosepiece, and a strap, according to some embodiments;

FIGS. 2A-2I show various views of a reusable mask and filters, according to some embodiments;

FIGS. 3A and 3B show views of a reusable face mask body having an elastic plug snap coupling mechanism configured to removeably receive a filter, according to some embodiments;

FIGS. 4A and 4B show views of a reusable face mask body having a cantilever snap insert with fill coupling mechanism configured to removeably receive a filter, according to some embodiments;

FIGS. 5A and 5B show views of a reusable face mask body having cantilever snap insert without fill coupling mechanism configured to removeably receive a filter, according to some embodiments;

FIGS. 6A-6C show various views of a compression ring that may be used to provide a better seal in some embodiments,

FIGS. 7A and 7B show views of a reusable face mask body having a twist and lock elastic coupling mechanism configured to removeably receive a filter, according to some embodiments;

FIGS. 8A-8E show various views of a reusable face mask body having a textured contact portion, according to some embodiments;

FIGS. 9A-9D show various views of a reusable face mask having a textured contact portion, according to some embodiments; and

FIGS. 10A and 10B show front and back images, respectfully, of a high-filtration reusable face mask having a textured contact portion, according to some embodiments.

### DETAILED DESCRIPTION

Described herein are high-filtration reusable face masks having various coupling mechanisms configured to removeably couple a filter to the high-filtration reusable face mask, as well as high-filtration reusable face masks having a textured contact portion configured to reduce the tackiness feel of the face mask body for the user. As described above, high-filtration reusable face masks that use replaceable filters include an attachment port configured to receive a replaceable filter. The coupling mechanisms described herein allow for a replaceable filter to be easily attached and easily removed from the reusable face mask body at the attachment port, while at the same time maintaining a tight seal when the filter is attached to the face mask body. The textured contact portion of the reusable face mask body is located around a perimeter of the face mask body, facing the user’s face. Thus, when the user wears the reusable face mask, only the textured contact portion comes in contact with the user’s face. The remaining portions of the face mask body are configured to be raised or spaced a distance from the user’s face. This textured contact portion reduced the tackiness of the face mask body, providing a more comfortable fit for the user. A more comfortably fitting reusable face mask can improve proper wear, and thus, safety of a user.

Additionally, the high-filtration reusable face masks provided are manufactured with a polymer having some transparency, such that at least a portion of the face mask body is transparent. This transparency of the face mask body can allow for increased communication between the mask-wearer and another. For example, in some embodiments, a transparent polymer may be used to form a transparent, or clear, mask body. With a transparent, or clear, mask body, another person can ascertain facial expressions from the mask-wearer as well as better understand the mask-wearer’s verbal language, since he or she can see the mask-wearer’s lips move as he or she speaks.

In some embodiments, the high-filtration reusable masks provided herein can be used in healthcare settings. Currently, only single use high-filtration masks can be used in healthcare settings. Reusable respirators are incompatible with healthcare standards because they include an exhale valve that breaks the sterile field, and they cannot be sterilized using accepted healthcare practices. However, the replaceable filters for use with the high-filtration reusable masks provided herein do not break the sterile field when a user exhales; additionally, the reusable mask bodies can be sterilized using an autoclave, which is an acceptable healthcare sterilization method.

High-filtration reusable face masks provided include at least one filter attachment port having a filter support structure that can receive a replaceable filter configured to removeably attach to the filter attachment port. The filter attachment port receives the replaceable filter such that, when the filter is in place on the filter attachment port, the filter support structure of the filter attachment port physically separates two sheets of filter media of the replaceable filter. Separating the two sheets of filter media allows for more air flow into and out of the filters with each inhale and exhale.

Replaceable filters for high-filtration reusable masks include two sheets of filter media attached around an outer edge and a support ring. The support ring is attached to a rim of an opening within one sheet of the filter media. The support ring is configured to snap on to the support structure of the attachment port of a reusable face mask and form an airtight seal with the filter attachment port. Each sheet of filter media may comprise layers of spunbond polypropylene and/or melt-blown polypropylene. The sheets of filter media may be in any shape such as, but not limited to, a circle, a triangle, a rounded triangle, a square, a rounded square, an oval, a rhombus, or a rounded rhombus.

High-filtration reusable face masks, and in particular, replaceable filters for high-filtration reusable face masks, are described in more detail with respect to U.S. Application 63/180,626, the entirety of which is incorporated herein.

Described below are (1) high-filtration reusable face masks with replaceable filters, (2) various coupling mechanisms that can be used to adequately couple a reusable filter to a high-filtration reusable face mask, and (3) reusable face mask bodies having a textured contact portion for reducing tackiness and increasing comfort.

### High-Filtration Reusable Face Masks With Replaceable Filters

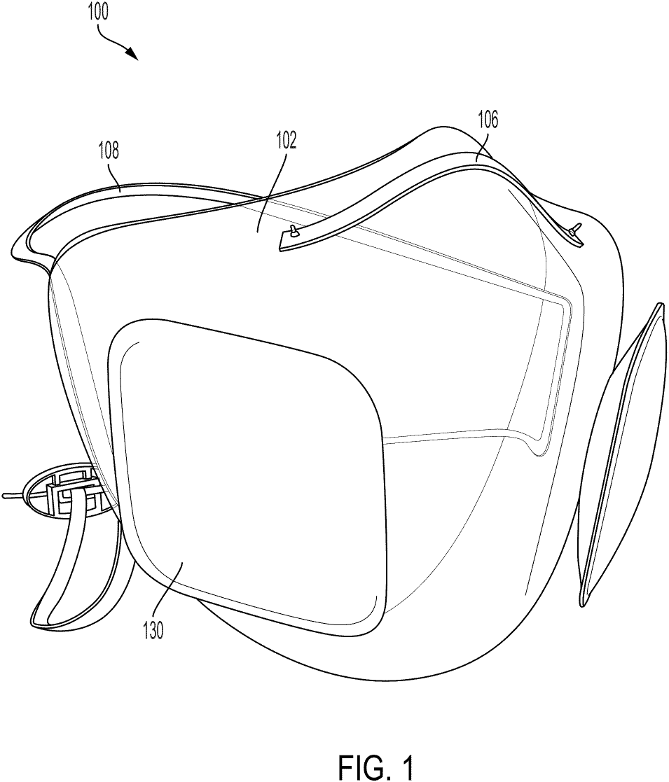

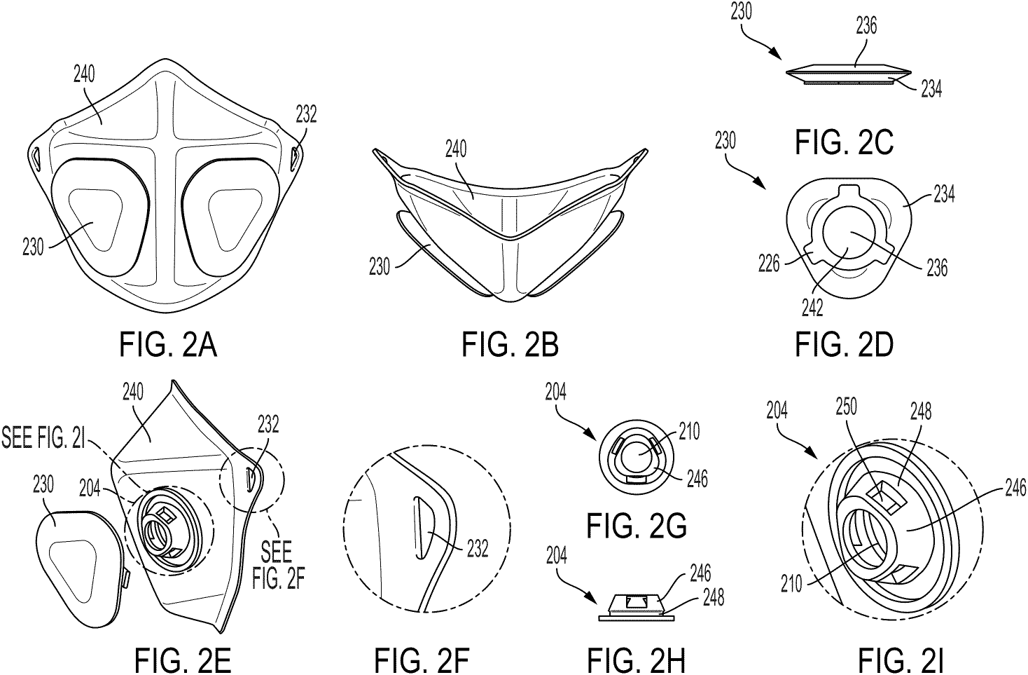

Reusable face masks with replaceable filters are designed for increased air flow and breathability, to generate less waste, and for increased communication between the mask-wearer and another person. Each of these benefits of high-filtration reusable face masks with removably attached filters is described in detail below with respect to FIGS. 1 and 2A-2I.

FIG. 1 shows a perspective view of a high-filtration reusable face mask 100 with replaceable filters, according to some embodiments. As shown, face mask 100 includes face mask body 102, nosepiece 106, strap 108, and replaceable filter 130. Each feature is described in detail below.

Face mask body 102 is configured to cover a nose and a mouth of a human face. An interior surface of face mask body 102 faces and is in contact with the human face of the user, and an exterior surface of face mask body 102 is opposite the interior surface and faces outward and away from the user’s face. The material, shape, and thickness of face mask body 102 is designed to provide a comfortable fit for the user, while at the same time providing a protective fit on the user’s face. In some embodiments, face mask body 102 may provide an airtight seal with the user’s face. The tighter the seal, the better protection the mask provides to the user.

In some embodiments, face mask body 102 may be made of a clear or transparent material. For example, suitable clear/transparent materials include elastomers such as silicone or thermoplastic polyurethane. In some embodiments, face mask body 102 may be made of a material having a transmittance of 60-100%, 70-100%, 80-100%, 85-100%, 90-100%, or 90-95%. In some embodiments, face mask body 102 may be made of a material having a transmittance of less than or equal to about 100, 95, 90, 85, 80, 75, 70, or 65%. In some embodiments, face mask body 102 may be made of a material having a transmittance of greater than or equal to about 60, 65, 70, 75, 80, 85, 90, or 95%. In some embodiments, face mask body 102 may be made of a material having a durometer of 40-60 or 45-55. In some embodiments, face mask body 102 may be made of a material having a durometer of less than or equal to about 60, about 55, about 50, or about 45. In some embodiments, face mask body 102 may be made of a material having a durometer of greater than or equal to about 40, about 45, about 50, or about 55. The durometer of the material is a Shore A durometer measured using CTM 0099 and press-cured for 5 minutes at 150° C. A suitable material for face mask body 102 may include DOW CORNING® C6-750.

In some embodiments, face mask body 102 may be made of an opaque material. In some embodiments, face mask body 102 may be made with a colorant, dye, or pigment to form a colored face mask body 102. In some embodiments, face mask body 102 may be made of a single piece. For example, face mask body 102 may be manufactured using injection molding to form a single-piece face mask body 102. In some embodiments, face mask body 102 is a single piece formed using a two-piece injection mold.

Nosepiece 106 comprises a relatively thin piece of metal attached to the exterior surface of face mask body 102. The position of nosepiece 106 can be adjacent to an upper edge of face mask body 102 and align with a location of the bridge of a user’s nose. In some embodiments, nosepiece 106 is bendable to allow for a user to bend and mold the nosepiece 106 to create a personalized fit to the user’s nose bridge. This can ensure a better fitting and more comfortable face mask, and thus more protective.

In some embodiments, nosepiece 106 comprises a metal such as aluminum, steel, stainless steel, or brass. In some embodiments, nosepiece 106 is connected to face mask body 102 by snapping onto one or more coupling protrusions. The one or more coupling protrusions are formed as part of the one-piece face mask body 102, and extend from the exterior surface of the face mask body 102. In some embodiments, the coupling protrusions comprise a distal portion and a proximal portion, the proximal portion connected to the face mask body 102. In some embodiments, the proximal portion is cylindrical in shape, and the distal portion extends radially such that the distal portion is slightly larger in a lateral direction than the proximal portion.

Strap 108 is configured to attach to face mask body 102 at two or more locations. At least one attachment location is at a right side of the face mask body 102, and at least one attachment location is at a left side of the face mask body 102, the left side corresponding to a left cheek of a user when wearing a mask, and the right side corresponding to a right cheek of a user when wearing the mask, the right side opposite the left side. Strap 108 is configured to wrap around the head of the user and help hold face mask body 102 in place to the user’s face. In some embodiments, strap 108 may be adjustable (e.g., ties, sliding adjustable clips, etc.) In some embodiments, two straps 108 may be used to hold face mask body 102 to a user’s face. In some embodiments, strap 108 is configured to clip to face mask body 102. Strap 108 may be made from materials such as elastic, cotton, silicone, or other suitable materials.

Face mask 100 is shown having two replaceable filters 130 each attached to a filter attachment port extending from the exterior surface of face mask body 102. Filter 130 comprises two sheets of filter media, attached at an outer edge. As shown in the figure, the two sheets of filter media are attached along the outer edge, following the rounded square outline. When unattached to a face mask body 102, filter 130 is in a collapsed, or flat configuration. When attached to a filter attachment port of a face mask body 102, filter 102 assumes an open, or expanded configuration. Filter 130 is caused to assume an expanded configuration due to the support structure of the filter attachment port. Filter attachment port is configured to receive filter 130 at an opening, such that the support structure of the filter attachment port extends into filter 130 and separates a portion of a first sheet of filter media from a portion of a second sheet of filter media.

Filter 130 may be in a rounded square shape, as shown. Other suitable shapes may include a circle, oval, square, triangle, rounded triangle, etc. Filter 130 may be configured to removably attach to face mask body 102, such that filter 130 may be replaced. Replacing filter 130 on a regular basis can help maintain optimal air flow, optimal filtration, and optimal protection from airborne particulates. In some embodiments, filter 130 may be a single-use filter.

FIGS. 2A-2I shows various views and components of a high-filtration reusable face mask, according to some embodiments. As shown, FIG. 2A shows a front view of a face mask having two replaceable filters, FIG. 2B shows a top view of a face mask having two replaceable filters, FIG. 2C shows a side view of a replaceable filter, FIG. 2D shows a rear view of a replaceable filter, FIG. 2E shows an exploded view of a face mask with a replaceable filter, FIG. 2F shows a close up view of a strap attachment location, FIG. 2G shows a close up front view of a filter attachment port, FIG. 2H shows a side view of a filter attachment port, and FIG. 2I shows a perspective view of a filter attachment port. Each figure is described in detail below.

FIG. 2A shows a front view of a face mask 240 having two replaceable filters, according to some embodiments. As shown, face mask 240 comprises two replaceable filters 230 and two strap attachment locations 232.

FIG. 2B shows a top view of a face mask 240 having two replaceable filters, according to some embodiments. In some embodiments, a thickness of face mask 240, as measured from the interior surface to the exterior surface, may be between about 0.5 and about 3 mm or between about 1 and about 2 mm. In some embodiments, a thickness of face mask 240 may be less than or equal to about 3, 2.8, 2.6, 2.4, 2.2, 2, 1.8, 1.6, 1.4, 1.2, 1, 0.8, or 0.6 mm. In some embodiments, a thickness of face mask 240 may be greater than or equal to about 0.5, 0.6, 0.8, 1, 1.2, 1.4, 1.6, 1.8, 2, 2.2, 2.4, 2.6, or 2.8 mm. If the thickness of face mask 240 is too thick, the mask will be uncomfortable to wear. If the thickness of face mask 240 is too thin, it will not have enough rigidity to form a protective seal with the face of the user. Additionally, face mask 240 may include any features of face mask 100 as described with respect to FIG. 1.

FIG. 2C shows a side view of a filter 230, according to some embodiments. Filter 230 includes a first sheet of filter media 234 and a second sheet of filter media 236. As shown, when filter 230 is not attached to a face mask, it is in a collapsed, or flat configuration. The first sheet of filter media 234 is attached to the second sheet of filter media 236 at an outer edge. Between the outer edges of filter 230, first sheet of filter media 234 and second sheet of filter media 236 are not attached.

FIG. 2D shows a rear view of a filter 230, according to some embodiments. Specifically, filter 230 of FIG. 2D shows the second sheet of filter media 236, opening 242 through the second sheet of filter media 236, interior surface of first sheet of filter media 234, and support ring 226.

When attached to a face mask, second sheet of filter media 236 is configured to face the exterior surface of the face mask. As shown, an opening 242 is formed through the first sheet of filter media 234, which is configured to receive a support structure of a filter attachment port of a face mask body. The support structure of a filter attachment port can extend into the filter 230 and press against interior surface of second sheet of filter media 236. By pressing against interior surface of second sheet of filter media 236, filter 230 changes from a flat, collapsed configuration to an expanded, or open configuration. In the expanded, or open, configuration, the support structure of the filter attachment port separates a portion of the second sheet of filter media 236 from a portion of the first sheet of filter media 234. In the configuration, the two sheets of filter media remain attached to each other at the outer edge. However, the separation increases the interior volume of filter 230, allowing more air to enter and exit filter 230 (i.e., through the first sheet of filter media 234 or the second sheet of filter media 236) and increasing the breathability of the face mask for the user.

Opening 242 may have a diameter of about 10-40 mm, 15-35 mm, or 20-30 mm. In some embodiments, opening 242 may have a diameter of less than or equal to about 40, 35, 30, 25, 20, or 15 mm. In some embodiments, opening 242 may have a diameter of greater than or equal to about 10, 15, 20, 25, 30, or 35 mm.

Support ring 226 may be attached to a rim of opening 242. Support ring is configured to provide support for filter 230 and to connect to the filter attachment port of the face mask body. In some embodiments, an inner surface of support ring 226 may be configured to provide a seal with the filter attachment port of the face mask body. In some embodiments, an inner surface of support ring 226 may be configured to provide an airtight seal with the filter attachment port of the face mask body. Support ring 226 may comprise a rigid polymer, such as polypropylene or polylactic acid. In some embodiments, support ring 226 may be biodegradable (e.g., polylactic acid). In some embodiments, support ring 226 may have an inner diameter (i.e., diameter of the opening of support ring 226) of 15-40 mm, 20-35 mm, or 25-30 mm. In some embodiments, support ring 226 may have an inner diameter of less than or equal to about 40, about 35, about 40, about 25, or about 20 mm. In some embodiments, support ring 226 may have an inner diameter of greater than or equal to about 15, about 20, about 25, about 30, or about 35 mm.

FIG. 2E shows an exploded view of a side view of a face mask 240 with filter 230, according to some embodiments. Specifically, FIG. 2E shows face mask 240 comprising an attachment location 232 for a strap and a filter attachment port 204. Attachment location 232 is described in more detail with respect to FIG. 2F, and filter attachment port 204 is described in more detail with respect to FIGS. 2G-2I.

FIG. 2F shows a close up view of a strap attachment location 232, according to some embodiments. A face mask according to some embodiments may comprise two strap attachment locations 232, one on each side of the face mask. Specifically, a first strap attachment location 232 may be located on a right side of the face mask body (e.g., corresponding to a location of a right cheek of a user) and a second strap attachment location 232 may be located on a left side of the face mask body (e.g., corresponding to a location of a left cheek of a user). In some embodiments, a face mask body may comprise four or more strap attachment locations 232. In some embodiments, a strap attachment location 232 may be configured to receive a strap by tying (i.e., tying the strap to the strap attachment location). In some embodiments, a strap attachment location 232 may be configured to receive a strap by clipping (i.e., the strap clips to the strap attachment location 232).

FIG. 2G shows a close up front view of a filter attachment port 204, according to some embodiments. As shown, filter attachment port 204 includes a central opening 210 and distal portion 246. In some embodiments, distal portion 246 comprises a support structure. Filter attachment port 204 extends from an exterior surface of a face mask body and, when a filter is attached to filter attachment port 204, a support structure (e.g., distal portion 246) of filter attachment port 204 extends into the filter. Thus, central opening 210 of filter attachment port 204 is configured to allow air flow to and from an exterior environment of a filter and the user’s nose and mouth. Central opening 210 extends through a proximal portion and a distal portion 246 of filter attachment port 204. The proximal portion is attached to the face mask body. The distal portion 246 is attached to the proximal portion. In some embodiments, distal portion 246 is in the shape of a frustum and has a lower base and an upper base, the lower base being greater in surface area than the upper base. In some embodiments, the upper base and/or the lower base of the frustum-shaped distal portion 246 may be circular, triangular, or in the shape of a rounded triangle. In some embodiments, the lower base of the distal portion 246 may be larger than and extend radially outwards past an upper base of the proximal portion, forming a ledge. In some embodiments, the proximal portion comprises an indentation configured to receive the support ring of a replaceable filter. In some embodiments, a width of the support structure (i.e., distal portion 246) may be 15-40 mm, 20-35 mm, or 25-30 mm. In some embodiments, a width of the support structure may be less than or equal to about 40, about 35, about 40, about 25, or about 20 mm. In some embodiments, a width of the support structure may be greater than or equal to about 15, about 20, about 25, about 30, or about 35 mm.

When a filter is attached to filter attachment port 204, the support ring of the filter is pushed over the distal portion 246, such that distal portion 246 may deform or contract to allow the support ring to snap/fit over. When properly attached to the filter attachment port 204, the support ring sits surrounding the proximal portion of the filter attachment port 204, and an interior surface of a second sheet of filter media rests against the upper base of the distal portion 246 of filter attachment port 204. The filter may be removed from filter attachment port 204 by pulling the support ring of the filter off the distal portion of the filter attachment port 204. In some embodiments, a replaceable filter is configured to lock or attach to the proximal portion of the filter attachment port 204 and the distal portion 246 of the attachment port 204.

In some embodiments, a face mask body may comprise 1, 2, 3, 4, 5, 6, 7, or 8 filter attachment ports. In some embodiments, a filter attachment port is configured to receive a single filter. In some embodiments, a filter attachment port is configured to receive two or more filters.

FIG. 2H shows a side view of a filter attachment port 204, according to some embodiments. As shown, FIG. 2H shows distal portion 246 (e.g., support structure) and proximal portion 248 of filter attachment port 204. The face mask body may be manufactured as a single piece, including the filter attachment port(s).

As described above, filter attachment port 204 comprises a distal portion 246 attached to a proximal portion 248, which is adjacent to the face mask body. In some embodiments, proximal portion 248 may be cylindrical and have an upper base and a lower base. In some embodiments, the distal portion may be frustum-shaped and have an upper base and a lower base. The lower base of the cylindrical proximal portion 248 may be adjacent to the face mask body exterior surface, and the upper base of the cylindrical proximal portion 248 may be adjacent to the lower base of the frustum-shaped distal portion 246. As described above, when a filter is connected to the filter attachment port 204, an inner surface of the support ring of the filter rests against and is in contact with a sidewall surface of proximal portion 248. Thus, the radius of cylindrical proximal portion 248 is slightly smaller than the inner radius of the support ring of a filter. In some embodiments, proximal portion 248 may comprise an indentation to allow for the support ring of a filter to attach to the filter attachment port 204.

As shown, the lower base of distal portion 246 is slightly larger than the upper base of cylindrical proximal portion 248. For example, lower base of frustum-shaped distal portion 246 may extend radially past an outer edge of the upper base of cylindrical proximal portion 248, creating a ledge or ridge. In some embodiments, proximal portion 248 may comprise an indentation, such that proximal portion 248 is smaller than distal portion 246.

FIG. 2I shows a perspective view of a filter attachment port 204, according to some embodiments. Filter attachment port 204 includes proximal portion 248, distal portion 246, central opening 210, and side openings 250.

As described above, filter attachment port 204 is configured to receive a filter such that, when the filter is attached to the mask body, it assumes an expanded configuration due to a support structure (e.g., distal portion 246) of the filter attachment port separating a portion of the two sheets of filter media of the filter. Specifically, one sheet of filter media sits against the upper base of the frustum-shaped distal portion 246, and another sheet of filter media is attached to the support ring, which surrounds the cylindrical proximal portion 248 of the filter attachment port 204. Thus, when the filter is connected to the filter attachment port 204, the entire distal portion 246 is positioned within the filter.

Central opening 210 and side openings 250 are configured to allow air to pass between an exterior environment of the filter and the nose and mouth of the user. Larger openings and more openings in number correspond to greater air flow and thus, greater breathability and comfort for the user. In some embodiments, a filter attachment port 204 may comprise 1, 2, 3, 4, 5, 6, 7, or 8 side openings 250.

### Coupling Mechanisms for High-Filtration Reusable Face Masks

As explained above, the replaceable filters are attached to the reusable face mask at an attachment port. However, there are various coupling mechanisms that can be used to attach and remove a replaceable filter from the reusable face mask body at the attachment port. Each of the various coupling mechanism described below enable a replaceable filter to be easily attached to the reusable face mask body as well as easily removed from the reusable face mask body. The various coupling mechanisms also ensure a tight seal when the replaceable filter is properly coupled/attached to the reusable face mask. In some embodiments, the coupling mechanisms may provide an airtight seal between the replaceable filter and the reusable face mask body.

In some embodiments, a coupling mechanism may provide an audible and/or tactile indicator to a user such that the user knows when a reusable filter is properly attached to the attachment port of the face mask body. For example, when attaching a filter to the face mask body, a “snap” sound may be made once the filter clears a ledge of the proximal portion of the attachment port. In some embodiments, the coupling mechanism is designed to provide resistance to the user when the reusable filter is being attached to the attachment port, however, once the reusable filter is properly attached, the coupling mechanism no longer provides resistance to the user. Additionally, the reusable filter cannot easily slide off once properly attached.

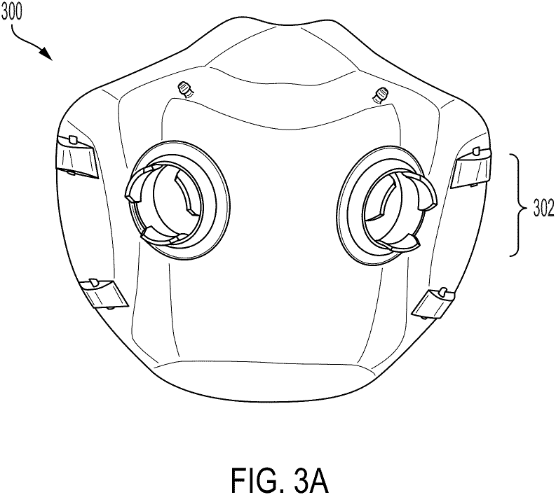

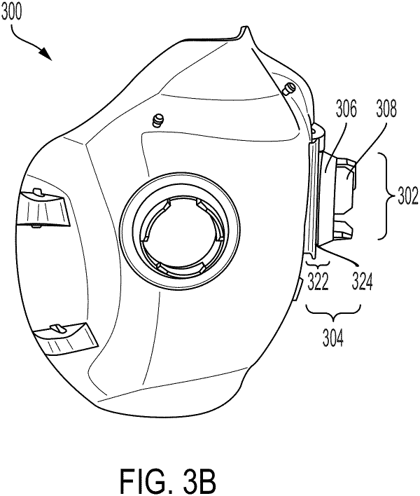

FIGS. 3A-3C show views of a reusable face mask body 300 having a coupling mechanism 302 configured to removeably receive a filter. Specifically, FIGS. 3 includes an elastic plug snap mechanism 302 located on attachment port 304. Attachment port 304 also includes a flange 322 to help ensure a tight seal. Each feature is described in detail below.

Face mask body 300 is designed to cover a nose and a mouth of a user. Face mask body 302 may include any features of any other face mask bodies described throughout this disclosure.

Filter attachment port 304 may include any features of any other filter attachment ports described within this disclosure. As shown, filter attachment port 304 extends from an exterior surface of face mask body 304 and comprises a support structure, defining a central opening.

Filter attachment port 304 includes coupling mechanism 302 located at the distal end of the filter attachment port 304. The coupling mechanism 302 shown in FIGS. 3A and 3B is specifically an elastic plug snap mechanism. An elastic plug snap mechanism includes a plurality of protrusions 308 extending from a proximal portion 306 of the attachment port 304. Specifically, the plurality of protrusions 308 extend away from the face mask body 300. The plurality of protrusions 308 are designed to separate the two layers of a reusable filter when the filter is properly attached to the attachment port 304. (As described above, the reusable filters comprise two layers of filter media.)

To couple a reusable filter to attachment port 304, the reusable filter (e.g., a rigid ring of the reusable filter) snaps over the proximal portion 306 of the attachment port 304 such that a coupling portion of the filter rests within the space 324 located between a ledge of the proximal portion 306 of the attachment port 304 and the outer surface of the face mask body 300.

In some embodiments, all components of an elastic plug snap mechanism comprise a flexible silicone.

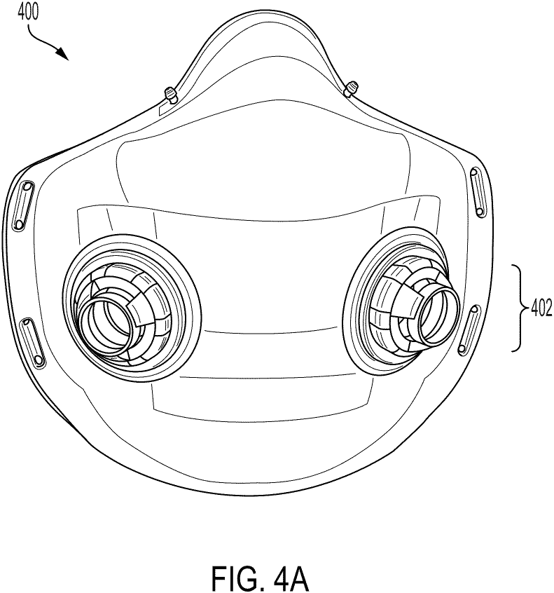

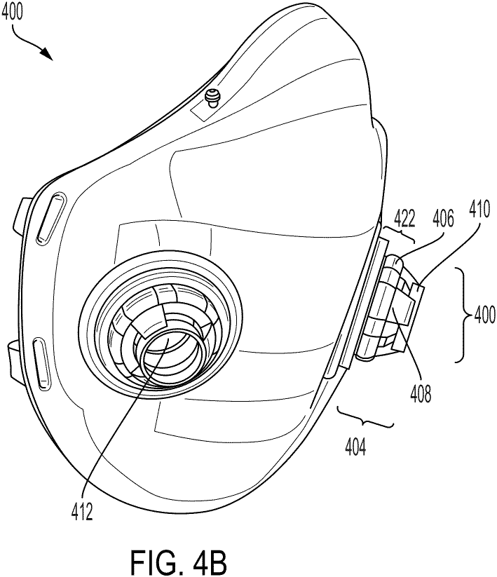

FIGS. 4A and 4B also show views of a reusable face mask body 400 having a coupling mechanism 402 configured to removeably receive a filter. However, the coupling mechanism 402 shown in FIGS. 4A and 4B is a cantilever snap insert with fill mechanism. Specifically, the cantilever snap insert with fill coupling mechanism is located on filter attachment port 404. Filter attachment port 404 further includes distal portion 406 and a proximal portion.

Filter attachment port 404 extends from an exterior surface of face mask body 400 and comprises a central opening 410. Filter attachment port 404 is configured to receive and hold a filter to the face mask body 400, as described in detail above. Further, filter attachment port 404 includes a proximal portion 406 located adjacent to an exterior surface of face mask body 400, as well as a distal portion described in more detail below.

The distal portion of filter attachment port 404 including a cantilever snap insert with fill mechanism 402 includes a plurality of protrusions extending from the proximal portion 406 of the filter attachment port 404. The plurality of protrusions 408 extend away from the facemask body 400. The proximal end of each protrusion 408 is adjacent to the proximal portion 406 of the filter attachment port 404, and the distal end of each protrusion 408 terminates at a ring 410. In some embodiments, the plurality of protrusions 408 taper inwards, such that an outer circumference of the ring 410 is smaller than a circumference of proximal end 406 of the filter attachment port 404. In some embodiments, there are two or more protrusions 408. In some embodiments, there are three, four, five, or six protrusions. The total number of protrusions 408 can affect the integrity and strength of the filter attachment port 404 (e.g., fewer protrusions 408 can provide a stronger filter attachment port 404). In some embodiments, the plurality of protrusions 408 are spaced evenly around opening 412. In some embodiments, the two-dimensional space between each protrusion 408 is greater than the outer surface area of each protrusion 408. In some embodiments, the outer surface area of each protrusion 408 is greater than the two-dimensional space between each protrusion 408.

In some embodiments, a portion of the attachment port 404 and/or the coupling mechanism 402 is formed of a rigid plastic molded separately from the silicone portion of the face mask body 400. For example, the rigid portion may comprise the plurality of protrusions 408 and ring 410. Once molded, this rigid portion may be placed in the face mask body mold, and the silicone face mask body may be molded such that the silicone portion of the attachment port 404 encapsulates at least a portion of the rigid plastic portion. In some embodiments, a chemical bond is formed between the rigid plastic portion the attachment port 404/coupling mechanism 402 and the silicone face mask body 400. For example, the rigid plastic portion may comprise polycarbonate, and the face mask body 400 may comprise silicone (e.g., selective self-adhesive silicone). In some embodiments, a mechanical bond is formed between the rigid plastic portion the attachment port 404/coupling mechanism 402 and the silicone face mask body 400.

As shown, the space in between two adjacent cantilevers comprises silicone from the molding of the face mask body. This design can provide more resistance when snapping the reusable filter onto the attachment port 404, since the individual protrusions 408 or cantilevers are not as able to flex or give, due to the silicone in between each one.

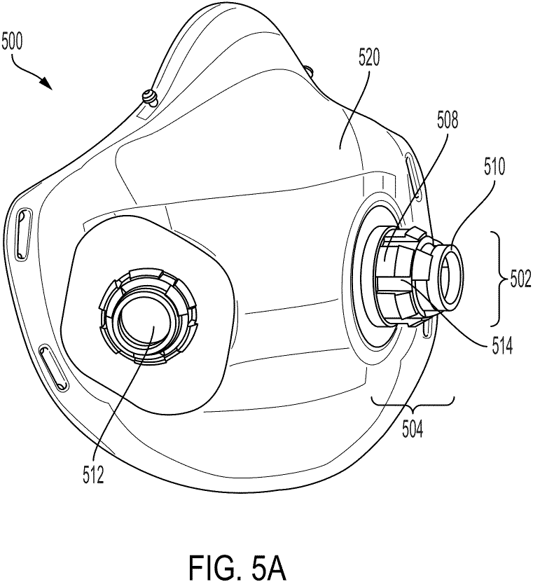

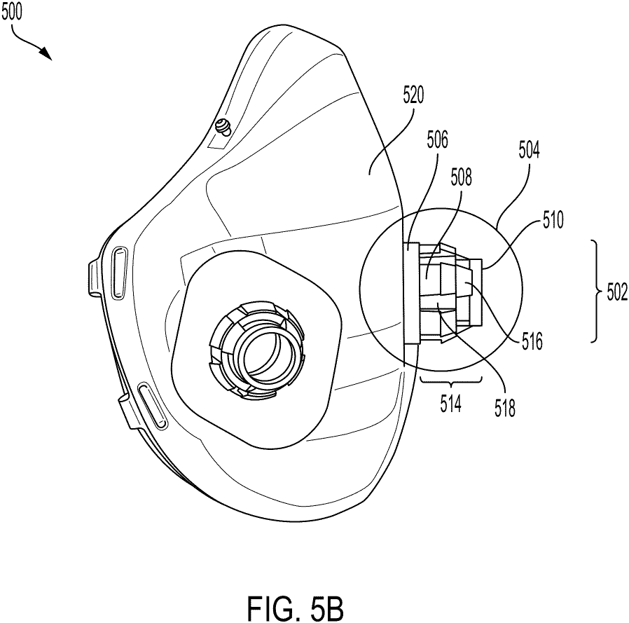

FIGS. 5A and 5B show views of a reusable face mask body 500 having coupling mechanism 502 configured to removeably receive a reusable filter, according to some embodiments. Specifically, coupling mechanism 502 is a cantilever snap insert without fill coupling. As shown, face mask body 500 also includes a filter attachment port 504 extending from the exterior surface 520 of the face mask body 500 and surrounding opening 512. Filter attachment port 504 comprises proximal portion 506, located adjacent to the exterior surface 520 of face mask body 500. This particular coupling mechanism, cantilever snap insert without fill, is characterized by negative space between each of the protrusions 508. This negative space can allow the plurality of protrusions 508 to more easily deform when a reusable filter is snapped onto the attachment port 504.

Cantilever snap insert without fill coupling 502 comprises a plurality of protrusions 508 extending from the exterior surface 520 of face mask body 500. The plurality of protrusions 508 surround an interior cylindrical protrusion 514 comprising a proximal portion 518 and a distal portion. The proximal portion 518 may be completely cylindrical and surrounding the opening 512, meaning that the proximal portion 518 may not include any spaces or cut-outs along the circumferential surface. However, at the distal portion, the cylindrical protrusion 514 may comprise a plurality of protrusions 516 extending from the proximal portion 518 of the cylindrical protrusion 514. Each protrusion 516 comprises extends from the proximal portion 518 of the cylindrical protrusion 514 and terminates at a ring 510. In some embodiments, the plurality of protrusions 516 taper inwards, such that an outer circumference of the ring 510 is smaller than a circumference of the proximal portion 518 of the of the cylindrical protrusion 514. In some embodiments, there are two or more protrusions 516. In some embodiments, there are three, four, five, or six protrusions 516. The total number of protrusions 516 can affect the integrity and strength of the cylindrical protrusion 514 (e.g., fewer protrusions 516 can provide a stronger cylindrical protrusion 514). In some embodiments, the plurality of protrusions 516 are spaced evenly around opening 512. In some embodiments, the two-dimensional space between each protrusion 516 is greater than the outer surface area of each protrusion 516. In some embodiments, the outer surface area of each protrusion 516 is greater than the two-dimensional space between each protrusion 516.

The cylindrical protrusion 514 is considered to be “internal” because the plurality of protrusions 508 extending from the proximal portion 506 of filter attachment port 504 can surround the cylindrical protrusion 514. In some embodiments, the plurality of protrusions 508 only surround the proximal portion 518 of the cylindrical protrusion 514. In some embodiments, unlike the plurality of protrusions 516, which can be tapered, the plurality of protrusions 508 are not tapered, but instead extend straight from the exterior surface 520 of the face mask body 500. In some embodiments, there are two or more protrusions 508. In some embodiments, there are three, four, five, or six protrusions 508. The total number of protrusions 508 can affect the integrity and strength of the coupling mechanism 502 (e.g., fewer protrusions 508 can provide a stronger coupling mechanism 502). In some embodiments, the plurality of protrusions 508 are spaced evenly around opening 512 or cylindrical protrusion 514. In some embodiments, the two-dimensional space between each protrusion 508 is greater than the outer surface area of each protrusion 508. In some embodiments, the outer surface area of each protrusion 508 is greater than the two-dimensional space between each protrusion 508.

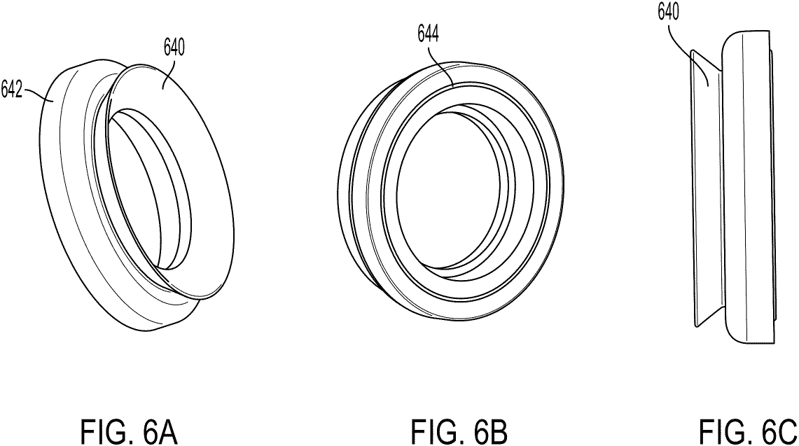

In some embodiments, a cantilever snap insert without fill coupling mechanism, as depicted in FIGS. 5A and 5B, is designed to be used with a separate compression ring, as shown in and described with respect to FIGS. 6A-6B. In some embodiments, a cantilever snap insert without fill coupling mechanism may include an integrated compression ring.

FIGS. 6A-6C shows various views of a compression ring 600, according to some embodiments. As shown, compression ring 600 includes a flange portion 640 and a base portion 642. The compression ring 600 is configured to slide over an attachment port of a high-filtration reusable face mask such that the compression ring 600 is situated between the outer surface of the face mask body and a reusable filter. The compression ring 600 helps ensure a tight seal between the reusable filter and the face mask body.

The compression ring 600 is configured to slide onto an attachment port of a face mask body such that the base portion 642 is adjacent to the outer surface of the face mask body. As shown in the figures, a bottom surface of the compression ring 600 comprises a raised ridge 644. This raised ridge 644 is configured to come in contact with the outer surface of the face mask body. Additionally, the raised ridge 644 allows for an axial seal to form between the reusable filter and the face mask body.

In some embodiments, the compression ring 600 may be configured to form a radial seal. In this case, the inner diameter of the compression ring 600 would be slightly smaller than the outer diameter of the proximal portion (e.g., proximal portion 506 of FIG. 5B).

When slid onto an attachment port, the flange portion 640 is configured to face outwards. When a reusable filter is coupled to the attachment port, the flange portion 640 is configured to face and be in contact with the reusable filter. The flange portion 640 specifically helps ensure a tight seal between the reusable filter and the face mask. In some embodiments, the compression ring 600 comprises silicone.

Compression ring 600 may be used in conjunction with any of the coupling mechanisms described herein. In some embodiments, a coupling mechanism may have an integrated compression ring and/or flange, rendering a separate compression ring, such as that described with respect to FIGS. 6A-6C.

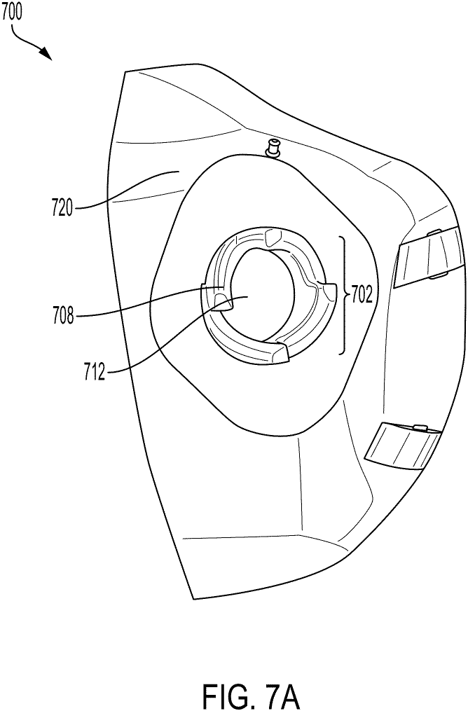

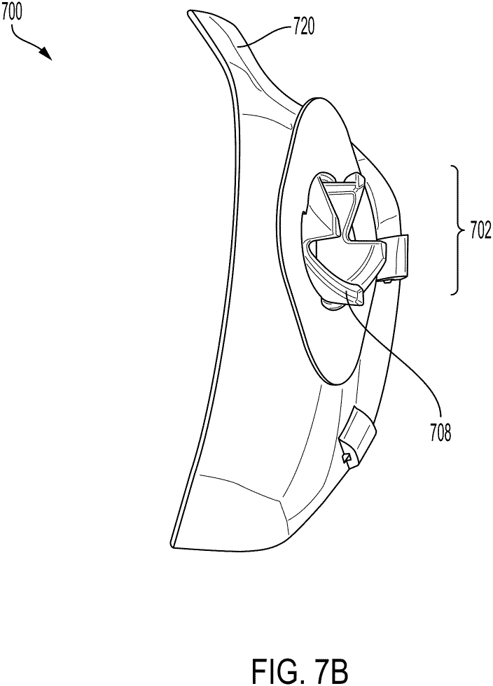

FIGS. 7A and 7B show views of a reusable face mask body 700 having coupling mechanism 702 configured to removeably receive a reusable filter, according to some embodiments. Specifically, coupling mechanism 702 includes a twist and lock elastic coupling mechanism.

As shown, twist and lock elastic coupling mechanism 702 includes a plurality of triangular protrusions 708 extending from the exterior surface 720 of the face mask body 700. The triangular protrusions 708 are configured such that they appear to be twisted or torqued. This means that the triangular protrusions 708 do not resemble an equilateral triangle, an isosceles triangle, or any other symmetrical triangle. Instead, the base of the triangular protrusions 708 is adjacent to the exterior surface of 720 of the face mask body 700, and the apex of the triangular protrusions 708 is located not centrally with respect to the base, but closer to one end of the of the base of the triangular protrusion 708. In some embodiments, one side of the triangular protrusion 708 may run perpendicular to a plane passing through the point at which the side extends from the exterior surface 720 of the face body 700.

To attach a reusable filter onto the twist and lock coupling mechanism of FIGS. 7A and 7B, the filter can be twisted onto the attachment port 704. When the filter reaches a proximal portion of the attachment port 704, it clicks or locks in place. The triangular protrusions 708 are designed to separate the two layers of filter media of the filter. The reusable filter can simply be twisted off to remove from the face mask body.

### Methods of Manufacturing Face Mask Bodies

In some embodiments, a face mask body may be molded using injection molding. In some embodiments, a face mask body may be a single piece manufactured using a single injection mold and a single shot of silicone.

In some embodiments, for example, in embodiments comprising a rigid plastic portion of the coupling mechanism/attachment port, the rigid plastic portion may first be manufactured using injection molding. Once manufactured, the rigid plastic portion may be placed into a second injection mold (i.e., an injection mold for the full face mask body). The face mask body injection mold may receive a shot of silicone, such that the silicone molds around a portion of the rigid plastic portion. Thus, the face mask body is formed such that the rigid plastic portion is integrated within the silicone portion.

### Textured Contact Portion

As explained above, high-filtration reusable face masks made of a polymeric material may provide a tacky or sticky feel to a user. However, it has been found that texturizing the surface of the polymeric reusable face mask can reduce the unpleasant tackiness/stickiness feel. Accordingly, high-filtration reusable face masks according to some embodiments described herein comprise at least a portion that is texturized. In some embodiments, the texturized portion comes in contact with the user’s face when the face mask is properly worn by the user. In some embodiments, the high-filtration reusable face masks described herein also include a non-texturized portion. The non-texturized portion can be transparent, such that the portions of the user’s face that are covered by the properly worn face mask are viewable by another person. In some embodiments, the face mask body wraps inward around the edges to form an inward facing rim that is configured to come in direct contact with a user’s face when properly worn. The surface of this inward-facing rim may be texturized to form a more pleasant wearing experience for the user.

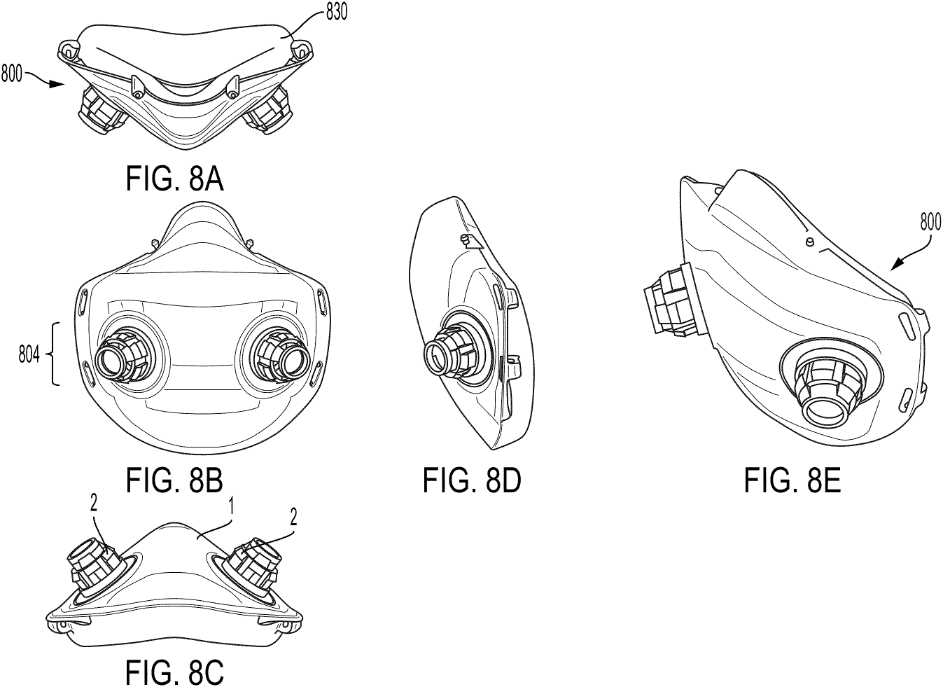

FIGS. 8A-8E show various views of a reusable face mask body 800 having a textured contact portion 830, according to some embodiments. A filter attachment port 804 is also indicated on face mask body 800.

As shown, textured contact portion 830 comprises an interior surface of face mask body 800. In some embodiments, textured contact portion 830 may only be located along a border rim of face mask body 800, such that only the textured contact portion 830 comes in contact with the user’s face. In some embodiments, the only surface of the face mask body 800 that comes in contact with a user’s face when the face mask body 800 is properly worn is the textured contact portion 830.

In some embodiments, the textured contact portion 830 is integral to the face mask body 800. In some embodiments, face mask body 800 comprises a single piece, including the textured contact portion 830. In some embodiments, the textured contact portion 830 is formed with an injection mold having a textured surface. In some embodiments, the face mask body 800 is formed using an injection mold having both a textured surface (to form the textured contact portion 830) and a non-textured surface. The textured contact portion 830 may extend from a front, transparent surface, and curl around and inwards towards an interior of the user-facing side of the face mask body 800.

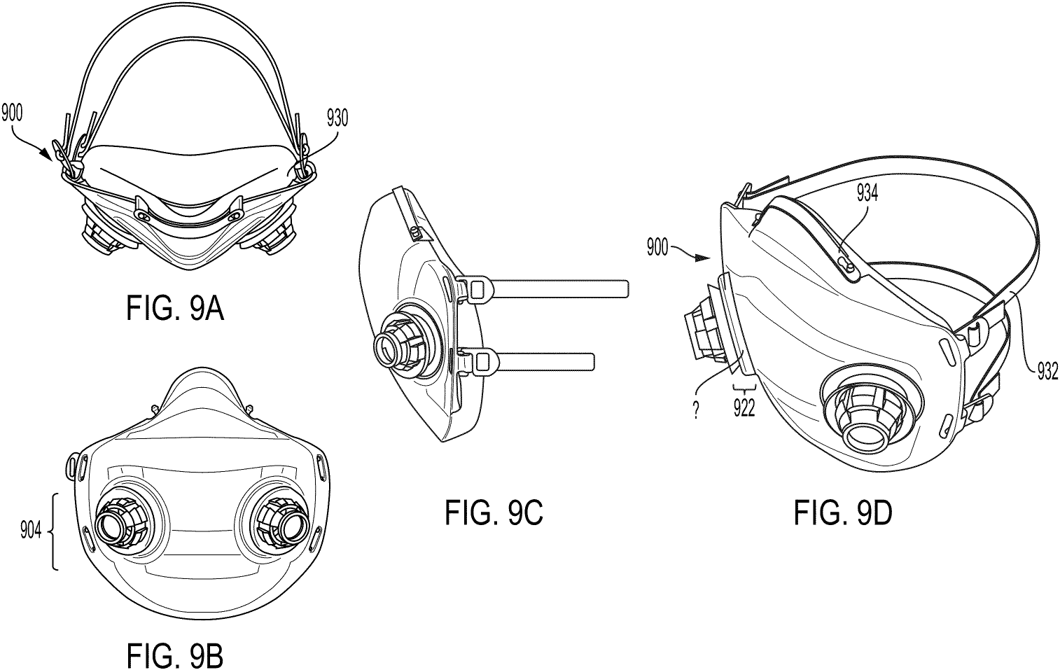

FIGS. 9A-9D show various views of a reusable face mask 900 having a textured contact portion 930, according to some embodiments. Also indicated is filter attachment port 904, strap 932, and nosepiece 906.

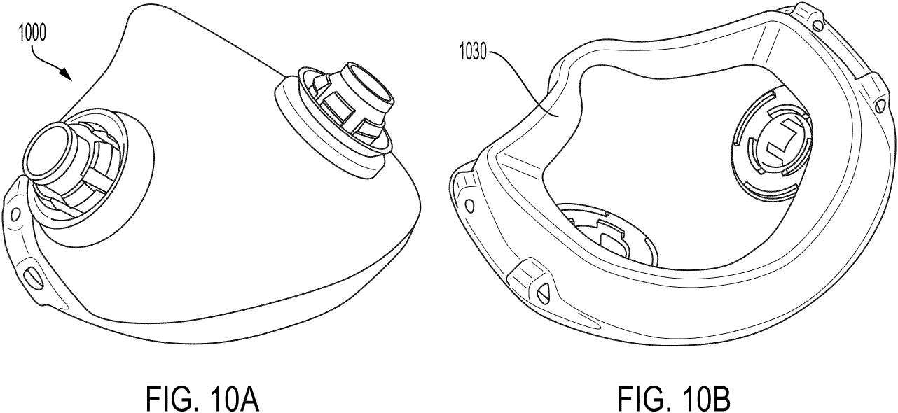

FIGS. 10A and 10B show front and back images, respectfully, of a high-filtration reusable face mask 1000 having a textured contact portion 1030, according to some embodiments.

In some embodiments, the face mask body of face mask 1000 is formed using a single injection mold. In some embodiments, the textured contact portion 1030 is formed with a textured finish (e.g., D1, D2, D3 finish/texture), and the non-textured portion is formed using a polished texture to ensure that the non-textured portion is optically clear/transparent. Because the contact textured portion 1030 is formed using a textured finish, it is optically translucent/opaque.

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, 0.5%, ±1%, 2%, 3%, ±4%, ±5%, ±6%, ±7%, ±8%, 9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, 0.1%, ±0.2%, ±0.3%, 0.4%, ±0.5%, ±1%, 2%, 3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

For any of the structural and functional characteristics described herein, methods of determining these characteristics are known in the art.

What is claimed is:

1. A reusable face mask comprising:
a single piece mask body configured to cover a nose and a mouth of a human face and comprising at least one filter attachment port, wherein the at least one filter attachment port comprises a coupling mechanism, defines an opening in the mask body, and extends from the exterior surface of the mask body;
wherein the coupling mechanism comprises a proximal portion proximate to the exterior surface of the face mask body, and a plurality of protrusions extending from the proximal portion and away from the exterior surface of the mask body, and a flange between the exterior surface and the proximal portion,
wherein the coupling mechanism of the at least one filter attachment port is configured to connect to a replaceable filter, and the flange is configured to provide a seal between the mask body and the replaceable filter.

2. The reusable face mask of claim 1, wherein the proximal portion and the plurality of protrusions surround the opening in the face mask body.

3. The reusable face mask of claim 1, wherein the plurality of protrusions extending from the proximal portion of the coupling mechanism are configured to support the replaceable filter by separating portions of filter media of the replaceable filter when the replaceable filter is attached to the at least one filter attachment port.

4. The reusable face mask of claim 1, wherein the coupling mechanism comprises a connection portion located between the exterior surface of the face mask body and the proximal portion, wherein the diameter of the connection portion is less than the diameter of the proximal portion.

5. The reusable face mask of claim 4, wherein the connection portion is cylindrical.

6. The reusable face mask of claim 4, wherein the replaceable filter is configured to snap over the proximal portion of the coupling mechanism such that an opening of the replaceable filter surrounds the connection portion.

7. The reusable face mask of claim 1, wherein the coupling mechanism comprises a compression ring, the compression ring comprising the flange.

8. The reusable face mask of claim 1, wherein the compression ring is integral with the single piece face mask body.

9. The reusable face mask of claim 1, wherein the compression ring is a separate component from the single piece face mask body.

10. The reusable face mask of claim 7, wherein the compression ring forms an axial seal between the face mask and the replaceable filter.

11. The reusable face mask of claim 1, wherein the coupling mechanism is configured to receive the replaceable filter by a snap fit mechanism.

12. The reusable face mask of claim 1, wherein the plurality of protrusions extending from the proximal portion are triangular in shape, and the coupling mechanism is configured to receive the replaceable filter by a twist and lock mechanism.

13. The reusable face mask of claim 1, wherein the mask body comprises a transparent polymer.

14. The reusable face mask of claim 1, wherein the mask body comprises a polymer having a transmittance of 80% or greater.

15. The reusable face mask of claim 1, wherein the mask body comprises one of silicone or thermoplastic polyurethane.

16. The reusable face mask of claim 1, comprising a user-facing rim comprising a textured surface, wherein the rim is configured to come in contact with a user’s face when the reusable face mask is properly worn by the user.

17. A reusable face mask comprising:
a mask body configured to cover a nose and a mouth of a human face and comprising at least one filter attachment port, wherein the at least one filter attachment port comprises a coupling mechanism, defines an opening in the mask body, and extends from the exterior surface of the mask body;
wherein the coupling mechanism comprises a rigid plastic portion and a flange, the rigid plastic portion comprising at least a portion of a proximal portion of the coupling mechanism proximate to the exterior surface of the face mask body and a plurality of protrusions extending from the proximal portion and away from the exterior surface of the mask body, and the flange positioned between the exterior surface and the proximal portion,
wherein the coupling mechanism of the at least one filter attachment port is configured to connect to a replaceable filter, and the flange is configured to provide a seal between the mask body and the replaceable filter.

18. The reusable face mask of claim 17, wherein the proximal portion and the plurality of protrusions surround the opening in the face mask body.

19. The reusable face mask of claim 17, wherein the plurality of protrusions of the coupling mechanism of the at least one filter attachment port are configured to support the replaceable filter by separating portions of filter media of the replaceable filter when the replaceable filter is attached to the at least one filter attachment port.

20. The reusable face mask of claim 17, wherein the coupling mechanism comprises a connection portion located between the exterior surface of the face mask body and the proximal portion, wherein the diameter of the connection portion is less than the diameter of the proximal portion.

21. The reusable face mask of claim 20, wherein the connection portion is cylindrical.

22. The reusable face mask of claim 20, wherein the replaceable filter is configured to snap over the proximal portion of the coupling mechanism until an opening of the replaceable filter surrounds the connection portion, such that the flange is between the replaceable filter and the exterior surface of the mask body.

23. The reusable face mask of claim 17, wherein the coupling mechanism comprises a compression ring, the compression ring comprising the flange.

24. The reusable face mask of claim 23, wherein the compression ring is integral with the single piece face mask body.

25. The reusable face mask of claim 23, wherein the compression ring is a separate component from the single piece face mask body.

26. The reusable face mask of claim 24, wherein the compression ring forms an axial seal between the face mask and the replaceable seal.

27. The reusable face mask of claim 17, wherein the proximal portion comprises a plurality of protrusions and a plurality of opening between the plurality of protrusions.

28. The reusable face mask of claim 17, wherein the proximal portion comprises both rigid plastic and silicone components.

29. The reusable face mask of claim 17, wherein the mask body comprises a transparent polymer.

30. The reusable face mask of claim 17, wherein the mask body comprises a polymer having a transmittance of 80% or greater.

31. The reusable face mask of claim 17, wherein the mask body comprises one of silicone or thermoplastic polyurethane.

32. The reusable face mask of claim 17, wherein the rigid plastic portion comprises polycarbonate.

33. The reusable face mask of claim 17, comprising a user-facing rim comprising a textured surface, wherein the rim is configured to come in contact with a user’s face when the reusable face mask is properly worn by the user.

34. A reusable face mask comprising:
a mask body configured to cover a nose and a mouth of a human face and comprising at least one filter attachment port and a user-facing rim comprising a textured surface,
wherein the at least one filter attachment port is configured to connect to a replaceable filter, and the rim is configured to come in contact with a user’s face when the reusable face mask is properly worn by the user.

35. The reusable face mask of claim 34, wherein the mask body is a single piece face mask.

36. The reusable face mask of claim 34, wherein the only portion of the mask body configured to come in contact with a user’s face when the reusable face mask is properly worn is the textured user-facing rim.

37. The reusable face mask of claim 34, wherein the textured rim is formed with one of a D1, D2, or D3 surface/finish using an injection mold.

38. The reusable face mask of claim 34, wherein the at least one filter attachment port comprises a coupling mechanism, defines an opening in the mask body, and extends from the exterior surface of the mask body.

39. The reusable face mask of claim 38, wherein the coupling mechanism comprises a proximal portion proximate to the exterior surface of the face mask body, and a plurality of protrusions extending from the proximal portion and away from the exterior surface of the mask body, and a flange between the exterior surface and the proximal portion, wherein the flange is configured to provide a seal between the mask body and the replaceable filter.

40. The reusable face mask of claim 38, wherein the coupling mechanism comprises a compression ring, the compression ring comprising the flange.

41. The reusable face mask of claim 40, wherein the compression ring is integral with the single piece face mask body.

42. The reusable face mask of claim 40, wherein the compression ring is a separate component from the single piece face mask body.

43. The reusable face mask of claim 40, wherein the compression ring forms an axial seal between the face mask and the replaceable filter.

44. The reusable face mask of claim 34, wherein the mask body comprises a transparent polymer.

45. The reusable face mask of claim 34, wherein the mask body comprises a polymer having a transmittance of 80% or greater.

46. The reusable face mask of claim 34, wherein the mask body comprises one of silicone or thermoplastic polyurethane.
